(19) United States
(12) Patent Application Publication
(10) Pub. No.: US 2021/0058265 A1
(43) Pub. Date: Feb. 25, 2021

(54) VIRTUALISATION OF A CONNECTED OBJECT

(71) Applicant: ORANGE, Paris (FR)

(72) Inventors: Stephane Petit, Chatillon Cedex (FR); Fabrice Marc, Chatillon Cedex (FR)

(21) Appl. No.: 16/958,291

(22) PCT Filed: Dec. 12, 2018
(86) PCT No.: PCT/FR2018/053224

§ 371 Date: Jun. 26, 2020

(30) Foreign Application Priority Data
Dec. 27, 2017 (FR) 1763260

(51) Int. Cl. H04L 12/28; H04L 29/08; H04L 29/12

(52) U.S. Cl. CPC H04L 12/281; H04L 61/6013; H04L 67/12

(57) ABSTRACT

A method for virtualizing a connected object of a communications network. The connected object has at least one main characteristic. The method includes: obtaining at least one identifier and at least one main characteristic of the connected object to be virtualized; obtaining at least one enrichment characteristic; and creating an avatar comprising: a first data structure comprising the main characteristic of the connected object; a second data structure comprising the enrichment characteristic; instructions of programs for implementing the enrichment characteristic; and an address management structure, a so-called proxy, comprising a correspondence at least between an avatar address and a connected object address.

### TECHNICAL FIELD

The invention relates to the general field of telecommunication networks, and more particularly to the Internet of Things.

### PRIOR ART

For several years now, the Internet of Things—or IoT—has been being deployed in the public sector and in the business world. Connected objects are for example domestic objects such as lightbulbs, lamps, radiators or even audio and video devices, electricity meters, vehicles, irrigation systems, etc. Connected objects dialog with one another via several categories of network, be these wired or wireless.

These objects may originate from the world of home automation, but may also more generally be any objects. A bus stop, which is not a traditional connected object, may however be of interest to a user who wishes for example to access functionalities such as journey timetables, alerts, etc. Following this same line of thought, multimedia content may be seen to be a connected object.

These objects are generally limited in terms of functionalities, in particular those that are not directly related to the service implemented by the object as initially intended by its manufacturer.

The invention offers a solution that does not exhibit the drawbacks of the prior art.

### THE INVENTION

To this end, according to one functional aspect, the invention relates to a method for virtualizing a connected object of a communications network, said connected object having at least one feature, called basic feature, said method being characterized in that it comprises the following steps on a virtualization device, in order to obtain an avatar able to represent the connected object:
obtaining at least one identifier of the connected object to be virtualized;
obtaining at least one basic feature of the connected object to be virtualized;
obtaining at least one enrichment feature for the connected object;
creating the avatar, said avatar comprising at least:
   said at least one identifier of the connected object;
   a first data structure comprising said at least one basic feature of the connected object;
   a second data structure comprising said at least one enrichment feature;
   program instructions for implementing said at least one enrichment feature;
   an address management structure, called proxy, comprising a correspondence at least between at least one address of the avatar and at least one address of the connected object.

“Connected object” is understood here to mean any physical or logic entity able to provide a service to a user in a communications network, for example:
connectable private equipments (smartphone, connected watch, connected headphones, home automation, etc.),
public domain equipments that the user is able to access,
“virtual” private objects, resulting from the processing of private data,
“virtual” public domain objects, resulting from the processing of public data and/or shared data (Open Data, Big Data),
content (films, music) and access to content.

A connected object comprises a set of features:
functions (giving the time, the temperature, streaming a video flow, etc.);
flows associated with the functions at the input or at the output of the object: commands, responses, messages, data flows, for example audiovisual data flows, etc. The term “flow” is considered here in the broad sense. For example, a message (command, request, response, acknowledgement, etc.) is a time-limited data flow.

“Virtualization” is understood to mean the creation of a virtualized object associated with a connected object and having an address for accessing the connected object. The virtual object, after it is created, offers or displays the features of the connected object and selected enrichment features according to embodiments that will be described below.

“Virtualized object” is understood to mean an object that comprises the connected object and its encapsulation according to the present invention, that is to say an avatar of the object.

“Avatar” is understood to mean a representation or enriched encapsulation of the object; the avatar therefore comprises:
one or more features of the object, basic or enriched features, and in the latter case a set of functions or associated implementation program instructions;
a proxy structure for allowing access to the connected object via the avatar of the virtualized object; this proxy structure is dedicated to the connected object.

Address of the connected object is understood to mean any type of address corresponding to the access of all or some of the features of the connected object. Such an address may be physical (http://192.145.1.1) or symbolic (zoom.ov3@mypasserelle.fr in order to access the zoom function of the camera object via the home gateway). It may take the form of a universal address (URI, URL), of an IP address, etc.

According to the invention, the accessible functions or the generated flows of a connected object may be encapsulated in a virtualized object such that the connected object is concealed behind the virtualized object.

Advantageously, a user of the connected object no longer accesses it directly, but via its avatar. The user therefore invokes the avatar in order to access the connected object. Encapsulating the data in this way in particular makes it possible to protect the object and to make it independent. For example, the (physical) connected object may be put into standby and awoken by its avatar when a request is addressed to the virtualized object.

The virtualized object, that is to say the entity formed by the connected object and its avatar, may implement the features of the connected object and selected enrichment features according to embodiments that will be described below.

Advantageously, the basic features of the object may be supplemented by other features that are managed not by the connected object itself but by the virtualized object corresponding thereto. For example, a webcam, which is a physical object, may be equipped with a hardware or software overlayer for managing its access times. New functions (for example a timestamp function) associated with new flows (for example the timestamp command and the timestamped output flow) are therefore added to the initial physical object (connected camera) having basic functions (image capturing, video capturing, zooming, rotating, etc.) and associated flows (image capturing command, zooming command, audiovisual output flow, etc.). These new features (functions and flows) are carried by the avatar. When the virtual object is used, its basic features (capturing an image) and/or its enrichment features (timestamping the image) may be called upon. If a basic feature is called upon, it is the connected object itself that is implemented by the avatar (for example in order to capture the image), in other words the commands, messages etc. are relayed thereto by the avatar (via its proxy) and the responses received by the avatar before relaying. If on the other hand it is an enrichment feature that is invoked, it is the program for implementing this feature of the avatar of the object that is used (since the connected object does not know this feature, it is impossible for it to implement said feature).

The invention thus makes it possible to enrich an object with features that do not form part thereof according to its initial specifications. In particular in the case of a physical object, the invention makes it possible to supplement it with useful functions that were not provided by the manufacturer.

According to one particular mode of implementation of the invention, a method as described above is furthermore characterized in that the enrichment step comprises the substeps of:
receiving a request to enrich the object, comprising at least one requested enrichment feature;
comparing the requested enrichment feature with the enrichment features of the avatar;
on the basis of the results of the comparison, validating said enrichment feature in the avatar.

Validation is understood to mean effectively bestowing the enriched feature on the virtualized object. The enriched feature is then accessible through the virtualized object. Specifically, it could have been written beforehand to the avatar without otherwise being authorized for implementation. The validation authorizes this.

Advantageously according to this mode, the user may request enrichment of his connected object. To this end, he establishes a request to the virtualization device. For example, he may request to enrich his camera with a clock. The techniques for the request may take any form within the scope of a person skilled in the art. It is possible for example to imagine that the user has a representation of the “camera” virtualized object on his smartphone or on his PC, and into which he slides a clock icon. In this case, if the avatar has a “clock” feature, this feature is validated in the avatar and becomes available as an enrichment feature of the virtualized object, in the same way as the basic features.

According to another particular mode of implementation of the invention, which may be implemented as an alternative or in addition to the previous one, a method as described above is furthermore characterized in that the enrichment step comprises validating all of the enrichment features available in the second data structure of the avatar.

Advantageously according to this variant, the enrichment is performed automatically. All of the enrichment features that have been obtained and provided in the structure of the avatar are added automatically to the virtualized object. For example, if the avatar has a “clock” feature and a “temperature” feature, these features are activated in the avatar and become available as enrichment features of the virtualized object, in the same way as the basic features.

According to another functional aspect, the invention also relates to a method for implementing a virtualized object of a connected object in a communications network, said virtualized object comprising an avatar of the connected object, the method being characterized in that it comprises the following steps on a device for implementing the virtualized object:
obtaining a message for using the virtualized object, said message comprising at least one feature to be implemented;
obtaining the avatar of the virtualized object, said avatar comprising at least:
   an identification of the connected object;
   a first data structure comprising at least one basic feature of the connected object;
   a second data structure comprising at least one enrichment feature;
   program instructions for implementing said at least one enrichment feature;
   an address management structure, called proxy, comprising a correspondence at least between at least one address of the avatar and at least one address of the connected object;
comparing the feature to be implemented with the features of the avatar;
on the basis of the results of the comparison:
   implementing the connected object if the feature to be implemented is a basic feature, and/or
   implementing the program for implementing an enrichment feature if the feature to be implemented is an enrichment feature.

The subjects according to this functional aspect of the invention afford at least the same advantages as those afforded by the method according to the first functional aspect. The optional features set forth for the first aspect may also be applied. In particular, the virtualized object encapsulates and enriches the connected object so as to be able to access not only the features (functions and flows) of the connected object, but also the enriched functions of the virtual object by virtue of its avatar.

It will additionally be noted that:
the message for using/implementing the virtualized object may originate from the connected object itself (for example if it raises the temperature every hour, or if an event has triggered the object—case of opening a door) or from any equipment of the network (terminal of the user, server in the network, etc.), or else from the virtualized object (which monitors for example the alerts from the connected object).
the requested feature (requested by the object itself or by an equipment of the network) may correspond to a function that is performed:
   by the physical object (zooming, the camera capturing an image, etc.);
   by the virtualized object (transmitting the time);
   or by a combination of the two (timestamping, that is to say transmitting the time in the flow).

According to one hardware aspect, the invention also relates to a device for virtualizing a connected object of a communications network, said object having at least one feature, called basic feature, the virtualization device comprising:
a module for obtaining at least one identifier and at least one basic feature of the connected object;
a module for generating an avatar;
a module for generating a first data structure comprising said at least one basic feature of the connected object;
a module for obtaining at least one enrichment feature for the connected object;
a module for generating a second data structure comprising said at least one enrichment feature for the connected object;
a module for obtaining program instructions for implementing said at least one enrichment feature;
an address management module for generating a data structure, called proxy, comprising at least one correspondence between at least one address of the avatar and at least one address of the connected object.

The term module used in the present description may correspond equally to a software component or to a hardware component or to a set of hardware and software components, a software component itself corresponding to one or more computer programs or subroutines or more generally to any element of a program able to implement a function or a set of functions as described for the modules in question. In the same way, a hardware component corresponds to any element of a hardware assembly able to implement a function or a set of functions for the module in question (integrated circuit, chip card, memory card, etc.).

According to another hardware aspect, the invention also relates to a device for implementing a virtualized object of a connected object in a communications network, the implementation device comprising:
a module for obtaining a message for using the virtualized object, said message comprising at least one feature to be implemented;
a module for obtaining the avatar of the virtualized object;
a module for obtaining a first data structure comprising at least one basic feature of the connected object;
a module for obtaining a second data structure comprising at least one enrichment feature;
a module for obtaining program instructions for implementing said at least one enrichment feature;
a module for obtaining an address management structure, called proxy, comprising a correspondence at least between at least one address of the avatar and at least one address of the connected object;
a module for comparing the feature to be implemented with the features of the avatar;
a module for implementing, on the basis of the results of the comparison:
   the connected object if the feature to be implemented is a basic feature, and/or
   the program for implementing an enrichment feature if the feature to be implemented is an enrichment feature.

According to another hardware aspect, the invention also relates to a home gateway comprising a virtualization device and/or an implementation device as described above.

According to another hardware aspect, the invention also relates to a virtualized object comprising:
a connected object having at least an identifier, a basic feature and an address;
an avatar of said connected object, comprising:
   an identification of the connected object;
   a first data structure comprising at least one basic feature of the connected object;
   a second data structure comprising at least one enrichment feature of the connected object;
   program instructions for implementing said at least one enrichment feature;
   an address management structure, called proxy, comprising at least one correspondence between at least one address of the avatar and at least one address of the connected object.

According to another hardware aspect, the invention also relates to a computer program able to be implemented on a virtualization device as described above, the program comprising code instructions that perform the steps of the virtualization method defined above when the program is executed by a processor.

According to another hardware aspect, the invention also relates to a computer program able to be implemented on a communication device as described above, the program comprising code instructions that perform the steps of the communication method defined above when the program is executed by a processor.

According to yet another hardware aspect, the invention relates to a recording medium able to be read by a data processor and on which a program comprising program code instructions for executing the steps of any one of the methods defined above is recorded.

The subjects according to the hardware aspects of the invention afford at least the same advantages as those afforded by the method according to the first functional aspect. The optional features set forth for the first aspect may be applied to the hardware aspects.

The invention will be better understood upon reading the following description, given by way of example and with reference to the appended drawings.

### THE FIGURES

FIG. 1 shows the general context of the invention, showing connected and virtual objects of a user of a local area network according to the prior art.

FIG. 2 illustrates a virtualized object according to one embodiment of the invention.

FIG. 3 illustrates an object avatar according to one embodiment of the invention.

FIG. 4 shows an architecture of a device for virtualizing objects and/or for implementing virtualized objects according to one embodiment of the invention.

FIG. 5 shows a timing diagram of the virtualization of an object and the subsequent implementation of the virtualized object according to one embodiment of the invention.

### DETAILED DESCRIPTION OF ONE EXEMPLARY EMBODIMENT ILLUSTRATING THE INVENTION

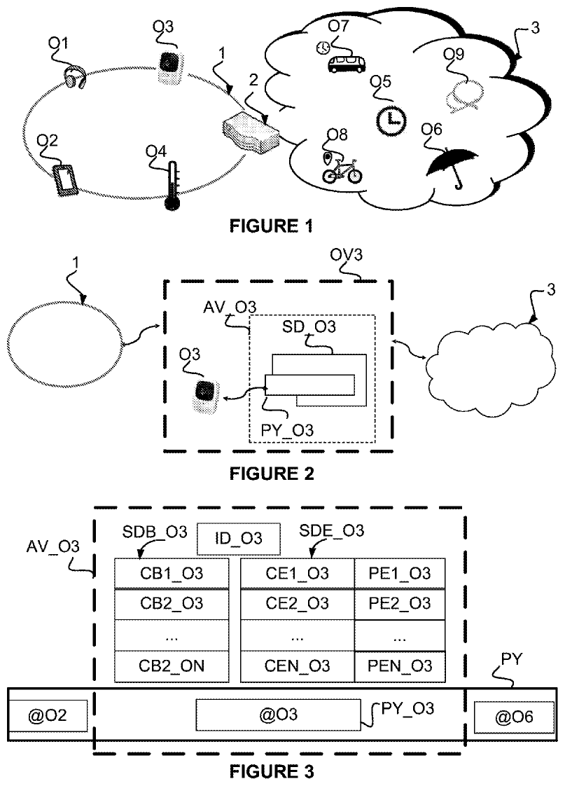

FIG. 1 shows the general context of the invention according to the prior art, showing connected and virtual objects of a user of a local area network or LAN 1. According to this non-limiting example, the LAN network is a home network connected to a wide area network or WAN, 3, for example an Internet network. More generally, a LAN network could be a business network or be limited to a single object connected to the Internet network (for example a beach webcam) and the WAN network 3 could be of any type (cellular, GSM—Global System for Mobile Communications, UMTS—Universal Mobile Telecommunications System, Wi-Fi—Wireless, etc.) without departing from the scope of the invention.

A network management element (2) (a home gateway, business gateway, a hub, etc.) and terminal equipments, hereinafter called connected objects or more simply objects (Oi), are connected to the local area network 1. According to the example, these are respectively connected headphones (O1), a smartphone (O2), a connected camera (O3) and a temperature sensor (O4). These objects are able to communicate on the local area network and are able to be accessed from inside or outside the local area network via the service gateway (2).

Other objects located in the wide area network (3) are of interest to a user of the local area network:
public objects: a bus stop (O7) with which traffic information, timetables, etc. are associated and a rain gauge (O6), and also a shared bicycle (O8), are shown by way of example
private objects on the public network: with which location information, state, etc. are associated. A social network account (O9) of the user is shown by way of example.

It will be noted that these objects are heterogeneous in nature:
physical object: this is a physical equipment with the ability to connect to the Internet. It may be a real-time or non-real-time information flow provider, and/or an actuator in the sense that receiving a particular information flow (for example commands) will prompt it to perform an action associated with a function. These objects may differ in terms of their operating system (Windows, Linux, Android, etc.), their type of connection to the network (Ethernet, Wi-Fi, Bluetooth, etc.), and the functions/actions of which they are capable: measuring the temperature, communicating on social networks, implementing a recipe, reading multimedia content, recording a surveillance video, transmitting it, detecting a movement, turning on a lamp, etc.
virtual object: a virtual object is not embodied by a physical equipment. It is merely a representation simulated by a digital entity. It is for example a timestamping function, a location function, etc.
physical/virtual object: in this case, the physical equipment exists and is accessible to physical people (for example via a graphical interface) but it is incapable of producing or processing an information flow. On the other hand, its activity is able to be simulated by a digital entity.

It will additionally be noted that these physical, virtual or physical/virtual objects may also be characterized in terms of property and access (they may be private, shared or public) without departing from the scope of the invention.

The table below illustrates these definitions: the left-hand column indicates the nature of the object (physical, virtual or physical/virtual) and the top row indicates its type (private or public).

TABLE 1
typology of the connected objects

| Type/nature | Private (LAN, WAN) | Public (WAN) |
|---|---|---|
| Physical | Headphones (O1) | Rain gauge (O6) |
| | Smartphone (O2) | |
| | Camera (O3) | Shared bicycle |
| | Temperature sensor | (O8) |
| | (O5) | |
| Physical/virtual | | Bus stop (O7) |
| Virtual | Social network | Clock (O4) |
| | (O9) | |

It may henceforth be noted that each of the objects has a certain number of features (input/output functions and/or flows) that could however be enriched in a useful manner with features that it does not natively have. According to some examples:
the camera does not have time information; however, it may be useful to timestamp its data;
the bicycle does not have an odometer; however, it may be useful to know the number of kilometers traveled;
the bus stop does not have traffic information; however, it may be useful to know its next scheduled service, to know whether the bus is on time, whether or not it is full, etc. This information (traffic, timetables) is available from the information system of the operator; it may be beneficial to consider the physical bus stop (non-connected object) to be a virtualized bus stop to which traffic and timetable functions have been added.

A description will now be given of one embodiment of the invention with reference to FIG. 2, the purpose of which is to offer the user a virtualized object, possibly an enriched virtualized object, corresponding to a connected object.

In the following example, the connected object is a physical object (a camera), but it could be virtual (a clock) without a loss of generality.

According to this example, the camera object of the local area network of the user (O3) will be enriched with a “function” that it does not natively have: a timestamping function (FH) originating from the wide area network; the flows of the camera may be timestamped and the time may also be transmitted to the virtualized object in response to a request. The camera is therefore provided with an additional feature (function and flow) via a hardware or software overlayer.

The resulting object is a virtualized object, that is to say a particular object corresponding to a connected object, able at least to perform its functions and process information flows to or from the (physical or virtual) connected object.

According to this embodiment of the invention, the virtualized object corresponding to a connected object is represented as an entity performing functions and having input and output flows. All of the flows of the connected object pass through a software assembly similar to a proxy, the object avatar, constructed on the flows from or in the direction of the object. This object avatar represents the object on the network. It will be noted that the connected object, if it has required hardware and software resources, may be autonomous on the condition that it is able to support the functions of the object avatar.

The avatar is therefore a “standardized” interface with capabilities that may also be standardized (timestamping). This is in a manner of speaking an overlayer of the object (encapsulation).

According to this embodiment of the invention, which will be described in more detail with reference to the following figures, the owner of the object first of all installs it on his home gateway. A virtualization device on the gateway constructs an avatar for the object. The avatar is thereafter accessible via a new address that is used to access the object. This avatar may also typically be implemented in the network of the operator if the home gateway is virtualized, or else in the network (cloud) on the condition that it implements a secure link between the avatar that is located in the network and the object. Likewise, some objects could directly integrate the avatar (connected objects) or implement it (in a case of the computer-based representation of a physical object).

The avatar that is created acts as a proxy between the connected object and the requests that are made thereto. It is recalled that a proxy (PY) is a software component that performs the role of a broker by being placed between two entities in order to facilitate the exchanges. In this case, the proxy (PY) of the avatar is placed between the user of the object, for example a website on a smartphone, and the object connected to the LAN/WAN. The proxy redirects the flows in a manner transparent to the user, to and from the connected object.

The avatar may have its own proxy or alternatively be attached to a proxy that groups together a set of avatars.

Once the avatar has been created, the type of the object is able to be identified and a reference database, for example, or the avatar that comprises the information itself may be used to recover the information regarding the interfaces (flows, functions) of the object and thus show or display them, for example in a graphical interface associated with the virtual object. For example, the avatar associated with the camera has zooming, scanning, coding formatting, fixed image capturing, etc. features and additionally, according to the example proposed above, timestamping functions.

The aim is to be able to adapt all of the connected objects to the needs of the user, regardless of their inherent features, via an enrichment mechanism.

FIG. 3 shows one possible architecture for an object avatar according to one embodiment of the invention in more detail. According to this example, it is the connected object O3 (the camera) that is considered to lead to a virtualized object (OV3). The avatar (AV_O3) comprises:
an identification (ID_O3) of the connected object;
a first data structure (SDB_O3) comprising at least one basic feature (CB1_O3, . . . CBN_O3) of the connected object (zooming, image capturing, video flows, capture command, etc.);
a second data structure (SDE_O3) comprising at least one enrichment feature (CE1_O3, . . . CEN_O3) of the connected object (timestamping, temperature, etc.);
program instructions (PEl_O3 . . . PEN_O3) for implementing the enrichment features (CE1_O3 . . . CEN_O3); specifically, the enrichment features are not implemented on the connected object, unlike the basic features. It is therefore necessary to provide a software overlayer in order to implement these features (for example: recover the time, transmit it in a flow, timestamp the flow, etc.)
an address management structure, called proxy (PY_O3), comprising a correspondence between at least one address of the avatar (@AV_OV3) and at least one address of the connected object (@O3). It is recalled that the address may be of any type and address all or some of the features of the connected object. Moreover,
either the object has its own proxy; schematically, in this case the object will be accessible via an address of the type/my camera
or it is attached to a proxy that comprises a set of avatars; schematically, in this case the object will be accessible via an address of the type proxy objects/my camera (and another object, for example a connected thermometer, will be accessible via proxy objects/my thermometer).

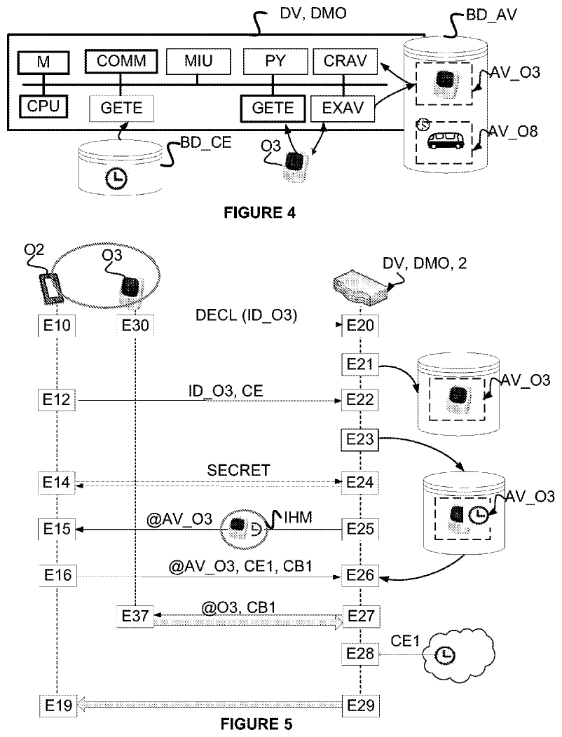

FIG. 4 shows an architecture of a device for virtualizing objects and/or for implementing virtualized objects according to one embodiment of the invention.

The virtualization device comprises:
memories (M) associated with a processor (CPU). The memories may be of ROM (read only memory) or RAM (random access memory) type. They may take the form of a removable card (SD, flash, etc.). Part of the memory M may in particular contain, according to the invention, the avatars corresponding to the virtualized objects.
a communication module (COMM) for communicating with the connected objects, with the user, and with various entities of the local area and/or wide area network; this module may be of Wi-Fi, Bluetooth, Ethernet etc. type and use any protocol suitable for dialoging with these entities (http, RTP, etc.);
a module for obtaining the basic features (GETB), making it possible for example to discover a physical object whose reference is communicated thereto (for example a camera) and to deduce the relevant basic features (functions and flows) of the object therefrom;
a module for obtaining the enriched features (GETE), making it possible to obtain a set of enriched features able to be associated with connected objects (for example timestamping, temperature, traffic, etc.); according to the example of FIG. 3, these data are read from a feature database (BD_CE); this database may or may not be located on the virtualization device (it may be in the cloud, on any equipment of the local area or wide area network, etc.);
an avatar generation module (CRAV) responsible for virtualizing the objects that are provided thereto, that is to say generating an avatar for a connected object, by enriching it with functions that it does not originally have.
a proxy management module (PY) that makes it possible to associate a proxy structure (PY_Oi) with one or more object avatars and thereafter to manage the flows to and from the object.
an avatar implementation module (EXAV) that makes it possible, once the object has been virtualized, that is to say its avatar has been created, to access the virtualized object (access the basic features corresponding to the features of the connected object and/or access the enrichment features offered by the avatar). It will be noted that, for the sake of simplicity, the module EXAV has been placed on the virtualization device. It could however form part of an avatar implementation device separate from the virtualization device.
an avatar database (BD_AV); this database may be located on the virtualization device or externally. It contains the avatars of the virtualized objects.
a user interface module (MIU) for making available or displaying an access address (@AV_O3) to said avatar (AV_O3) and the features of the avatar of the object to the user (for example in the form of a graphical object that may be transmitted to the user, as shown in following FIG. 4: representation of the object in the form of pictograms and associated functions).

FIG. 5 shows a timing diagram of the virtualization of a connected object and of the subsequent implementation of the virtualized object.

It describes in particular the creation of an object avatar on the object virtualization device located according to this example on a home gateway, and the subsequent use of this object by its owner. It comprises the main virtualization phases (declaration of the connected object, creation and enrichment of the avatar), displaying the virtualized object (making it available to the user) and then implementing the virtualized object according to some examples.

According to this embodiment, the virtualization device (DV) and the device (DMO) for implementing the virtualized objects are coincident and are located on the service gateway. Any other location of one and/or the other of these two devices could be contemplated: in the local area network, in the wide area network, carried by a server, a terminal, a connected object, etc.

i. Virtualization of the Object

The aim of this phase is to create a virtualized object (OV3) representing a connected object (O3). It is recalled that the virtualized object corresponds to the connected object and its avatar.

In a preliminary step E10/E30, the user declares a connected object. According to this example, this is a connected camera (O3) of the local area network. The connected object to be virtualized is therefore physical, but it could be virtual without a loss of generality (for example, the bus stop presented above with reference to FIG. 1 is represented by a computer system). Any other object could be considered without a loss of generality, as described with reference to FIG. 1. Several methods may be used:
the connected object declares itself to the service gateway (name of the camera, model, etc.);
the user himself provides the features of the object;
etc.

In a step E20, the virtualization device receives the declaration of the object and prepares a virtualized object, or avatar, having the features of the (physical or virtual) object that has just been declared. In order to obtain these features, the gateway (module DEC) may, as the case may be:
interrogate a reference site for the object in order to receive its function and flow features (for example the site of the manufacturer for a camera);
receive this information from the connected object or from the owner.

In a step E21, the virtualization device (CRAV) virtualizes the object, that is to say creates a data structure and a set of associated software (or hardware) features, called avatar (AV), for this object. The avatar is a software overlayer of the object that possesses/has the functions and the flows of the object. It is recalled that it comprises a structure carrying the basic features of the connected object and a structure carrying the possible enrichment features of the object with the associated implementation programs. It is moreover associated with a proxy for creating the link between the addresses of the virtualized object and the addresses of the connected object.

Such avatars are outlined below by way of explanatory example for the “camera” object (table 2) and the “bicycle” object (table 3):

TABLE 2
example of an avatar of a virtualized camera
Proxy (PY_O3)
@O3 <=>@AV_O3

| | | | | |
|---|---|---|---|---|
| | basic | | enriched | Enriched |
| Identifier | functions | Basic flow | functions | flow |

Data structure

| | | | | |
|---|---|---|---|---|
| BrandXX | image | image flow | clock | Clock |
| | capturing | zoomed image | timestamping | timestamped |
| | zooming | flow | | flow |

Programs

| | | |
|---|---|---|
| Program for | Program for | Program for converting |
| accessing the clock {. . .} | timestamping | the clock data {. . .} |
| | the flow {. . .} | |

TABLE 3
example of an avatar of an enriched bicycle
Proxy (PY_O8)
@O8 <=>@AV_O8

| | | | | |
|---|---|---|---|---|
| | basic | | enriched | Enriched |
| Identifier | functions | Basic flow | functions | flow |

Data structure

| | | | | |
|---|---|---|---|---|
| BrandYY | geolocation | GPS | odometer | kilometers |
| | | coordinates | | traveled |

Programs

| | | |
|---|---|---|
| Program for accessing | Program for | Program for inserting |
| the odometer {. . .} | rendering | the odometer into a |
| | the | GPS coordinate flow |
| | odometer | {. . .} |
| | {. . .} | |

According to the embodiment of FIG. 4, the enrichment features (and the associated programs) are extracted from an enrichment feature database (BD_CE).

According to one mode of implementation, all of the enrichment features inserted into the avatar in the previous step are validated automatically in the virtual object, that is to say that these features of the virtual object may be implemented.

According to another embodiment, all of the enrichment features inserted into the avatar in the previous step are offered, but are not validated automatically. In this case, in a step E12, the user requests effective enrichment of the object with an enrichment feature. According to the example shown, he requests to enrich the camera with a clock function (CE). To this end, he may for example enter a pictogram of the connected object and a pictogram of a clock object and bring the two pictograms together on a graphical interface. Any other method may be contemplated for achieving the transmission of a message carrying an identifier of the object (identifier ID_O3 of the connected object, or its address, or the address of the avatar currently being created if this address has been transmitted to the user, etc.) and at least one enrichment feature.

It will be noted that the two embodiments may be combined if only some of the enrichment features are validated automatically.

The virtualization device receives this request in step E22 and processes it in step E23. It verifies that the avatar is actually provided with the requested enrichment feature, and then it validates this feature in the avatar if this is the case. Lastly, it stores the avatar in the avatar database.

Optionally, the avatar is also provided with a representation of the virtualized object. This representation may be of any type (graphical, text, audio, etc.). It is accessible for example on the smartphone of the user, who is able to receive this representation and then “sees” the virtualized object in the form of an HMI; for example the representation associated with the camera object may show/display, with the representation of the camera:
the functions of stopping on an image, slowing down, rewinding, fast-forwarding.
the commands corresponding to the associated input flows (for example, the user is able to rewind the video by clicking a button);
the output flow of the camera;
etc.

At the end of these steps, the virtualized object therefore has an avatar comprising at least the basic features of the connected object, a proxy for accessing it in a transparent manner via the address of the avatar, and possibly a graphical representation.

Optionally, the user (on his smartphone) and the proxy are able to exchange a secret in steps E14 and E24 in order thereafter to be able to communicate securely.

ii. Displaying the Object (Making the Object Available)

In steps E25 and E15, the virtualization device provides the owner of the connected object with the address of the virtualized object, that is to say the avatar address (@AV_O3) contained in the proxy of the avatar. By virtue of this address, the user is able to access the virtualized object; in addition, in this step, the virtualization device is also able to provide a representation (HMI) of the object via its user interface module (MIU).

The owner of the connected object, provided with the address of the object avatar (@AV_O3) and possibly the shared secret (S) and a representation (HMI) of the object, is now able to connect to the avatar, for example via a graphical interface that is displayed on his smartphone.

iii. Implementation of the Object

According to one exemplary implementation of the virtualized object, the owner of the connected object decides, in a step E16, to implement the virtualized object. To this end, he prepares a message for the virtualized object (on the address @AV_O3 that has been previously communicated to him) by requesting a basic feature (CB1) and an enrichment feature (CE1) of the object, according to this example a camera shot (CB1=image capturing, see for example table 2) and a timestamp of the captured image (CE1=timestamping).

The device for implementing the virtualized object on the gateway (module EXAV) receives this message in a step E26 and analyzes it. To this end, it interrogates the avatar database in order to obtain the avatar (AV3) of the object.

By virtue of the avatar, said device recognizes the first feature as a basic feature (CB1=image capturing, see for example table 2, is located in the basic structure) and the second feature as an enrichment feature (CE1=timestamping).

Following this analysis, it is therefore able:
in a step E27, to transmit the order to capture an image to the camera connected object (O3) and recover the captured flow in return;
in a step E28, to call the program of the avatar linked to the “timestamping” enrichment feature (see table 2);
and then, in a step E29, to relay the timestamped flow to the terminal of the user.

It goes without saying that the embodiment that has been described above has been given purely by way of indication and without limitation, and that numerous modifications may easily be made by a person skilled in the art without otherwise departing from the scope of the invention.

Numerous variants may be contemplated in particular with regard to the implementation of the virtualized object:
the implementation may be triggered by the connected object itself, for example if said connected object is a motion sensor, it may trigger implementation of the “camera” virtual object OV3 when it detects a movement. The detection signal is received by the virtualized object and possibly enriched before being transmitted for example to a remote server.
the implementation may be triggered by the virtualized object itself; the avatar of the virtualized object monitors the connected object. It transmits an order to capture an image thereto in a step similar to step E27; it recovers the shot, possibly enriches it (through timestamping, etc.) and transmits it to a remote server.
etc.

1. A method for virtualizing a connected object of a communications network, said connected object having at least one feature, called basic feature, said method comprises the following acts performed on a virtualization device, in order to obtain an avatar able to represent the connected object:
obtaining at least one identifier of the connected object to be virtualized;
obtaining at least one basic feature of the connected object to be virtualized;
obtaining at least one enrichment feature for the connected object; and
creating the avatar, said avatar comprising at least:
said at least one identifier of the connected object;
a first data structure comprising said at least one basic feature of the connected object;
a second data structure comprising said at least one enrichment feature;
program instructions for implementing said at least one enrichment feature;
an address management structure, called proxy, comprising a correspondence at least between at least one address of the avatar and at least one address of the connected object.

2. The method for virtualizing a connected object as claimed in claim 1, wherein the enrichment act furthermore comprises subacts of:
receiving a request to enrich the object, comprising at least one requested enrichment feature;
comparing the requested enrichment feature with the enrichment features of the avatar;
on the basis of the results of the comparison, validating said enrichment feature in the avatar.

3. The method for virtualizing a connected object as claimed in claim 1, wherein the enrichment act comprises validating all of the enrichment features available in the avatar.

4. A method for implementing a virtualized object of a connected object in a communications network, said virtualized object comprising an avatar of the connected object, the method comprising the following acts on a device for implementing the virtualized object:
obtaining a message for using the virtualized object, said message comprising at least one feature to be implemented;
obtaining the avatar of the virtualized object, said avatar comprising at least:
an identification of the connected object;
a first data structure comprising at least one basic feature of the connected object;
a second data structure comprising at least one enrichment feature;
program instructions for implementing said at least one enrichment feature;
an address management structure, called proxy, comprising a correspondence at least between at least one address of the avatar and at least one address of the connected object;
comparing the feature to be implemented with the features of the avatar;
on the basis of the results of the comparison:
implementing the connected object in response to the feature to be implemented being a basic feature, and/or
implementing the program instructions for implementing an enrichment feature in response to the feature to be implemented being an enrichment feature.

5. A device for virtualizing a connected object of a communications network, said object having at least one feature, called basic feature, the virtualization device comprising:
a processor; and
a non-transitory computer-readable medium comprising instructions stored thereon which when executed by the processor configure the device to:
obtain at least one identifier and at least one basic feature of the connected object;
generate an avatar;
generate a first data structure comprising said at least one basic feature of the connected object;
obtain at least one enrichment feature for the connected object;
generate a second data structure comprising said at least one enrichment feature for the connected object;
obtain program instructions for implementing said at least one enrichment feature;
generate a data structure, called proxy, comprising at least one correspondence between at least one address of the avatar and at least one address of the connected object.

6. A device for implementing a virtualized object of a connected object in a communications network, the device comprising:
a processor; and
a non-transitory computer-readable medium comprising instructions stored thereon which when executed by the processor configure the device to:
obtain a message for using the virtualized object, said message comprising at least one feature to be implemented;
obtain an avatar of the virtualized object;
obtain a first data structure comprising at least one basic feature of the connected object;
obtain a second data structure comprising at least one enrichment feature;
obtain program instructions for implementing said at least one enrichment feature;
obtain an address management structure, called proxy, comprising a correspondence at least between at least one address of the avatar and at least one address of the connected object;
compare the feature to be implemented with the features of the avatar;
implementing, on the basis of the results of the comparison:
the connected object in response to the feature to be implemented being a basic feature, and/or
the program instructions for implementing an enrichment feature in response to the feature to be implemented being an enrichment feature.

7. The device for virtualizing as claimed in claim 5, wherein the device is implemented in a home gateway.

8. A virtualized object on a non-transitory computer-readable medium, comprising:
a connected object having at least an identifier, a basic feature and an address;
an avatar of said connected object, comprising:
an identification of the connected object;
a first data structure comprising at least one basic feature of the connected object;
a second data structure comprising at least one enrichment feature of the connected object;
program instructions for implementing said at least one enrichment feature; and
an address management structure, called proxy, comprising at least one correspondence between at least one address of the avatar and at least one address of the connected object.

9. (canceled)

10. (canceled)

11. The device for implementing as claimed in claim 6, wherein the device is implemented in a home gateway.
